(19) United States
(12) Patent Application Publication
(10) Pub. No.: US 2019/0335776 A1
(43) Pub. Date: Nov. 7, 2019

(54) PRODUCE RIPENING

(71) Applicant: Walmart Apollo, LLC, Bentonville, AR (US)

(72) Inventors: Benjamin D. Enssle, Bella Vista, AR (US); Jesse Lee Eaton, Springdale, AR (US); David Blair Brightwell, Bentonville, AR (US); Greg A. Bryan, Centerton, AR (US); Jeffrey Kerbs, Bentonville, AR (US)

(21) Appl. No.: 16/402,327

(22) Filed: May 3, 2019

Related U.S. Application Data
(60) Provisional application No. 62/666,956, filed on May 4, 2018.

(51) Int. Cl. A23B 7/152; B65D 77/04; B65D 77/24; B65D 77/22; B65D 85/34

(52) U.S. Cl. CPC A23B 7/152; B65D 77/04; B65D 77/24; B65D 2203/12; B65D 85/34; A23V 2002/00; B65D 77/225

(57) ABSTRACT

Produce ripening systems and apparatuses are described. A produce ripening apparatus may include a sealed inner package positioned inside a sealed outer package. The sealed inner package may be breakable and may seal a ripening agent inside the sealed inner package. The sealed outer package may be openable and may have an elasticity sufficient to allow pressure to be applied to the sealed inner package through squeezing of the sealed outer package without breaking the sealed outer package. The pressure may be sufficient to break the sealed inner package.

### RELATED APPLICATION(S)

This application claims the benefit of U.S. Provisional Patent Application No. 62/666,956 filed on May 4, 2018 entitled “Produce Ripening,” the contents of which are incorporated herein by reference in their entirety.

### TECHNICAL FIELD

The technical field generally relates to ripening produce. More particularly, the technical field relates to produce ripening systems and apparatuses for produce sellers and consumers.

### BACKGROUND

Produce may be purchased by retailers, grocers, and/or consumers for sale or consumption but may spoil easily or sooner than desired. This may lead to excessive waste of produce and money. Additionally, it may be difficult to determine when the produce will be ripe for consumption. It may also difficult to control when the produce becomes ripe. All of these factors may make a farm-to-table cycle difficult to achieve without wasting produce.

### BRIEF SUMMARY

In an example, a produce ripening apparatus may include a sealed inner package positioned inside a sealed outer package. The sealed inner package may be breakable and may seal a ripening agent inside the sealed inner package. The sealed outer package may be openable and may have an elasticity sufficient to allow pressure to be applied to the sealed inner package through squeezing of the sealed outer package without breaking the sealed outer package. The pressure may be sufficient to break the sealed inner package.

In an example, the produce ripening apparatus may also include a ripeness indicator visible outside of the sealed outer package. The ripeness indicator may be configured to indicate a degree of ripeness of produce in the sealed outer package in response to detecting a concentration of a substance associated with the produce that indicates the degree of ripeness of the produce.

One or more of the following features may be included. At least one of the sealed inner package and the sealed outer package may be made from a polymer. At least one of the sealed inner package and the sealed outer package may be substantially transparent. The sealed outer package may seal a substance inside the sealed outer package to preserve produce in the sealed outer package. At least one of the sealed inner package and the sealed outer package may be resealable. The produce inside the sealed outer package may be exposed to the ripening agent once the sealed inner package is broken. The ripening agent may be ethylene. The ripeness indicator may indicate a degree of ripeness of the produce via a color-coded indicator. A valve extending from inside of the sealed inner package through which the seal of the sealed inner package may be breakable. Upon breaking the seal of the sealed inner package, the ripening agent may enter the sealed outer package through the valve. The produce may be a banana.

In an example, a produce ripening apparatus may include a sealed inner package positioned inside a sealed outer package. The sealed inner package may be breakable upon engagement of a pin device. The sealed inner package may seal a ripening agent inside the sealed inner package. The sealed outer package being openable.

In an example, the produce ripening apparatus may also include a ripeness indicator visible outside of the sealed outer package. The ripeness indicator may be configured to indicate a degree of ripeness of produce in the sealed outer package in response to detecting a concentration of a substance associated with the produce that indicates the degree of ripeness of the produce.

One or more of the following features may be included. The pin device may be engageable via a button. Upon actuating the button, a seal of the sealed inner package may be broken and the ripening agent may enter the sealed outer package from the inner package. At least one of the sealed inner package and the sealed outer package may be made from a polymer. At least one of the sealed inner package and the sealed outer package outer may be substantially transparent. The sealed outer package may seal a substance inside the sealed outer package to preserve produce in the sealed outer package. At least one of the sealed inner package and the sealed outer package may be resealable. The ripening agent may be ethylene. The ripeness indicator may indicate a degree of ripeness of the produce via a color-coded indicator. The produce may be a banana.

In an example, a produce ripening apparatus may include a sealed inner package positioned inside a sealed outer package that is substantially transparent. The sealed inner package may be breakable and may seal a ripening agent inside the sealed inner package. The sealed outer package may be openable and may have an elasticity sufficient to allow pressure to be applied to the sealed inner package through squeezing of the sealed outer package without breaking the sealed outer package. The pressure may be sufficient to break the sealed inner package. The produce ripening apparatus may also include a ripeness indicator visible outside of the sealed outer package. The ripeness indicator may be configured to indicate a degree of ripeness of produce in the sealed outer package in response to detecting a concentration of a substance associated with the produce that indicates the degree of ripeness of the produce. The produce inside the sealed outer package may be exposed to the ripening agent once the sealed inner package is broken

### BRIEF DESCRIPTION OF THE DRAWINGS

The above and further aspects of examples of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 depicts an example produce ripening apparatus in accordance with the present disclosure.

FIG. 2 also depicts an example produce ripening apparatus in accordance with the present disclosure.

FIG. 3 depicts an example pin device in accordance with the present disclosure.

### DETAILED DESCRIPTION

In brief overview, a produce ripening apparatus may include a sealed inner package positioned inside a sealed outer package. The sealed inner package may be breakable and may seal a ripening agent inside the sealed inner package. The sealed outer package may be openable and may have an elasticity sufficient to allow pressure to be applied to the sealed inner package through squeezing of the sealed outer package without breaking the sealed outer package. The pressure may be sufficient to break the sealed inner package. The apparatus may also include a ripeness indicator visible outside of the sealed outer package. The ripeness indicator may be configured to indicate a degree of ripeness of produce in the sealed outer package in response to detecting a concentration of a substance associated with the produce that indicates the degree of ripeness of the produce.

Processes may be used for industrially for exposing a ripening agent to the produce, such as bananas or other fruits or vegetables, at a desired time. Using the techniques and features described in the present disclosure, a retailer or consumer may conveniently expose a ripening agent to the produce on a smaller commercial scale in order to ripen the produce at a desired time. Thus, using the techniques and features described in the present disclosure the amount of spoiled produce in the supply chain may be reduced because accelerated ripening occur and be controlled much closer to a time of consumption.

For example, a produce ripening system or apparatus may include a transparent outer package. Bananas or other fruit or produce may be sold packaged in the hermetically sealed, neutral environment of the outer package (which may include, e.g., nitrogen gas). A sealed portion of the package may include a ripening agent such as ethylene. The bananas or other produce may be sold as individually packaged items, which may of value to consumers for whom a bunch of bananas may spoil in too short a window of time. This may force the consumer to buy bananas or other produce more often. The bananas or other produce could also be packaged by the bunch. A partition between, e.g., the nitrogen in the outer package and, e.g., the ethylene in the inner package may be broken by the consumer in a prescribed manner at a prescribed time such that with the bananas inside the inner package become ripe at close to a time of planned consumption. The package may include a chemically reactive visual aid or indicator which reacts in the presence of ethylene or a fruit of produce aroma to indicate when the fruit produce has reached a desired ripeness.

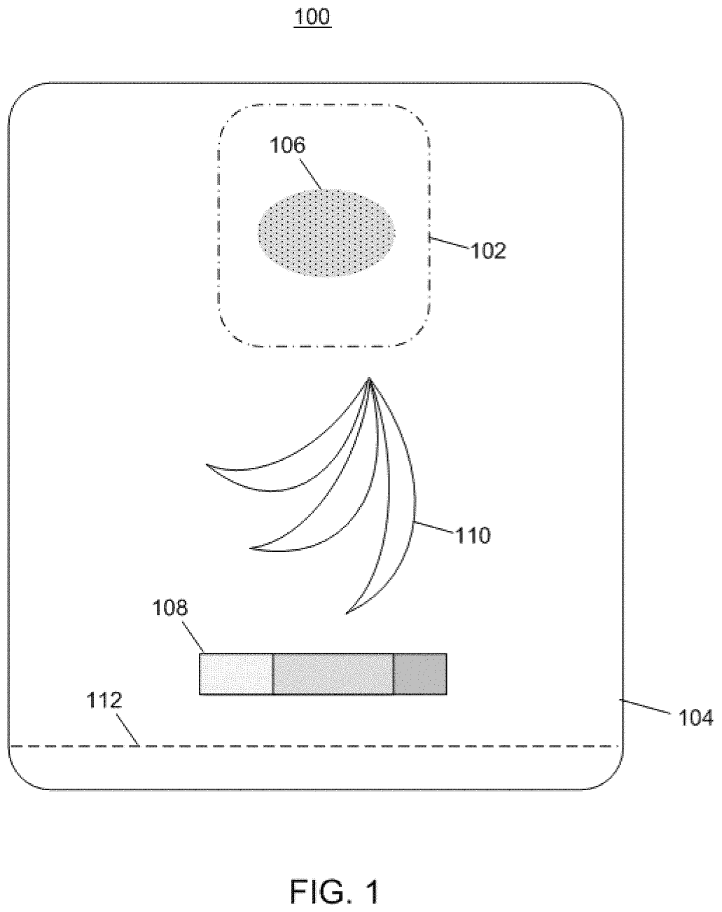

Referring now to FIG. 1, in an embodiment, a produce ripening apparatus 100 is shown. Produce ripening apparatus 100 may include a sealed inner package 102 positioned inside a sealed outer package 104. Sealed inner package 102 may be breakable (e.g., as indicated by dotted lines) and may seal a ripening agent 106 inside sealed inner package 102. Sealed outer package 104 may be openable and may have an elasticity sufficient to allow pressure to be applied to sealed inner package 102 through squeezing of (or pushing or otherwise applying pressure to) sealed outer package 104 without breaking sealed outer package 104. The pressure may be sufficient to break sealed inner package 102.

The sealed inner package may include a ripening agent and produce inside the sealed outer package may be exposed to a ripening agent once the sealed inner package is broken. The ripening agent may be ethylene. The ethylene used may or may not be in gas form. The ripening agent may have an ethylene concentration of about 50-1,000 parts per million (ppm). The amount of produce (e.g., by volume) in the sealed outer package and a desired ripening time may be used to determine a volume or concentration of the ripening agent (e.g., ethylene) required or to be maintained in the sealed outer package (e.g., at a desired ppm concentration). Apparatus 100 may also include ripeness indicator 108 visible outside of sealed outer package 104. Ripeness indicator 108 may be configured to indicate a degree of ripeness of produce 110 in sealed outer package 104 in response to detecting a concentration of a substance associated with produce 110 that indicates the degree of ripeness of produce 110.

In an implementation, sealed outer package 104 may be openable through a zip lock seal 112 or other perforated portion of sealed outer package 104. At least one of the sealed inner package and the sealed outer package may be resealable via a zip lock or other seal. For example, a glue-strip may be used to create a resealable inner or outer package. For example, in an implementation, produce ripening apparatus 100 may be sold without produce and/or a ripening agent. The purchaser may add the ripeness agent and/or produce later and sell the produce ripening apparatus once it has been stocked with produce and/or ripening agent. In an implementation, the outer package may be resealable but the inner package including the ripening agent may not be resealable.

Produce ripening apparatus 100 may be portable and may be sold be a retailer at a store and purchased and taken home by a consumer. In an implementation, produce ripening apparatus 100 may have multiple inner packages or chambers which may allow for different types of ripening agents or produce to be sold in the same commercial unit.

Inner package 102 and outer package 104 may each have a different Young's modulus such that outer package 104 can withstand a squeeze from a consumer sufficient to break inner package 102. The inner package or outer package may have a Young's modulus in the range of 25-50 megapascals (MPa). In an implementation, achieving the rupturing of inner package 102 without the rupturing outer package 104 (i.e., in response to a squeeze of other pressure) may be facilitated by constructing inner package 102 and outer package 104 from materials with different Young's moduli such that inner package 102 is more likely to rupture before outer package 104. For example, in an implementation, a material with a Young's modulus similar to mylar may be used (at least in part) to construct inner package 102, and a material with a Young's modulus similar to latex may be used (at least in part) to construct outer package 104. In an implementation, the difference or variability in the Young's modulus of the material used to construct inner package 102 and the Young's modulus of the material used to construct outer package 104 may be maximized as much as possible (without overlap). In an implementation, inner package 102 has a frangible or otherwise breakable seal breakable seal. Internal package 102 may still be hermetically sealed.

In an implementation, at least one of the sealed inner package and the sealed outer package may be made from a polymer. The sealed inner package and the sealed outer package may be made from a plastic material such as polyethylene vinyl, or acetate. Sheets of these materials may be sealed together to form one or more of the sealed inner package and the sealed outer package. In an implementation, the outer package may be made from a variety of impermeable substances or non-plastic materials such as kraft paper with a coating. For example, the outer package may be made from materials similar to those used to create a BioPlus Terra® II Fold-Pak by WestRock Company of Atlanta, Ga., which may include a coating by Cascades Sonoco, Inc., of Hartsville, S.C., such as a SurfShield™ coating. In an implementation, the outer package may include a variety of different types of seals which may or may not be impermeable, as the outer package in some implementations may only be required to keep the ripening agent (e.g., ethylene of a certain concentration) for a specific amount of time in order to initiate the ripening process.

For example, inner package 102 and outer package 104 may be made from the same or different polymers and outer package 104 may be made from a more elastic material. The elasticity of the inner and outer packages may be designed such that a stress/strain relationship between the two exists where the inner package breaks but the outer package does not break, in response to a certain amount of pressure or force. In an implementation, the inner package volume may be filled almost completely (or overfilled such that the inner package is slightly stretched) and/or slightly pressurized with a gas ripening agent (e.g., ethylene) such that the inner package may rupture under relatively little applied force or deformation (e.g., by squeezing). Further, the outer package may be filled less completely (e.g., 10%-50%) with air, another gas, and/or produce, etc. The smaller, more fully-filled inner package may be biased to one end of the larger, less-fully filled outer package such that the user may apply a sufficient squeeze/force to rupture the inner package. Once the inner package ruptures, most or all of the gas ripening agent (e.g., ethylene) may displace from the inner package to the outer package such that the user's applied force (e.g., by a first closing almost entirely or pressure from two hands) does not risk rupturing the outer package (for example, and for illustrative purposes only, consider a filled or overfilled water balloon inside a larger sealed garbage bag not fully filled with air). The outer package may be empty enough such that the user can almost fully squeeze the broken inner package (e.g., in their nearly closed first) to displace nearly all of the gas ripening agent (e.g., ethylene) from the inner package without deforming the outer package enough to break the outer package. If the outer package is sufficiently larger than the inner package, an outer package filled about 25% may allow for the inner package to break but for the outer package to stay intact, in response to a certain amount of pressure or force applied to the inner package from the outside of the outer package.

In an implementation, outer package 104 may be formed from a double layer of the same material as inner package 102 to ensure that the outer package is strong enough to withstand more pressure than the inner package. Further, in an implementation, inner package 102 may include a seal (not shown) in a bottom portion of the package which may be more easily ruptured in response to pressure on the inner package 102. In this way, a bottom portion of inner package 102 may rupture and this may direct the ripening agent in inner package 102 towards produce 110. This is in part because a user of produce apparatus 100 may hold or carry the apparatus upright as shown in FIG. 1, which may force the contents of the apparatus downward.

In an implementation, at least one of the sealed inner package and the sealed outer package may be substantially transparent. In an implementation, either of the inner and outer packages may be anywhere from 0-100% transparent.

Ripeness indicator 108 may indicate how ripe the produce is or when the produce is ready for consumption. The ripeness indicator may indicate a degree of ripeness of the produce via a color-coded indicator. For example, a red status or darker status may indicate that the ripening process has not been started (e.g., inner package 102 has not been broken). For example, banana ripening can be a seven day process where various colors of the banana may indicate a level of ripeness. These levels of ripeness or more particular or granular levels of ripeness may be indicated by the ripeness indicator.

In an implementation, ripeness indicator 108 may use Ripesense™ technology of Ripesense Limited of Tauranga, New Zealand to indicate a level of ripeness. For example, ripeness indicator 108 may be responsive to one or more aromas produced by the produce and may change color when it reacts to the one or more aromas produced by the produce as ripeness occurs.

In an implementation, the sealed outer package may seal a substance inside the sealed outer package to preserve the produce. For example, the original state of the produce may be preserved with nitrogen or another gas or agent in the outer package. The original or initial state of the fruit may be unripe to partially ripened.

Further, in an implementation, a valve extending from inside of the sealed inner package through which the seal of the sealed inner package may be breakable may be included. Upon breaking the seal of the sealed inner package, the ripening agent may enter the sealed outer package through the valve. In an implementation, the valve may be up to 5 inches in length and may be made from various metals or plastics.

The techniques and features of the present disclosure have been described using bananas and an example produce however bananas have been used for illustrative purposes only and this is not a limitation of the present disclosure. The techniques and features of the present disclosure may be implemented using a variety of other produce, including but not limited to: apples, apricots, cantaloupes, guavas, honey dew melons, kiwis, nectarines, passionfruit, peaches, pears, persimmons, plums, tomatoes, dates, mulberries, plantains, mangos, avocados, papayas, and other produce.

It should be noted that FIG. 1 is shown for illustrative purposes only and other implementations and/or embodiments are with the scope of the present disclosure. For example, in an embodiment, an ethylene gas section may exist in an internal bladder and may be released in response to a actuating a pin or push button pin device which may puncture an internal valve. The internal valve may allow fluid communication between the internal bladder and an external or outer package holding produce. A ripeness indicator may indicate when the produce is ready or at optimal ripeness for consumption. For example, a red status or darker status may indicate that a ripening process has not been started (e.g., the internal bladder is not punctured).

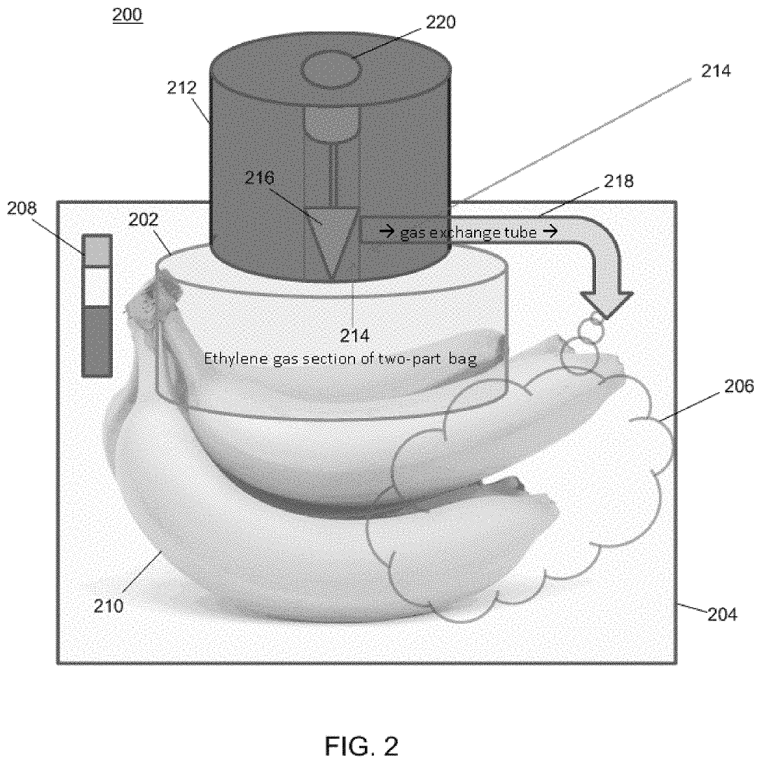

Referring now to FIG. 2, a produce ripening apparatus 200 is shown. Produce ripening apparatus 200 is an embodiment of the present disclosure and may be used in a store by a retailer to control ripeness of produce or purchased and taken home by a consumer. In various implementations, produce ripening apparatus 200 may have similar specifications, be constructed from similar materials, and incorporate similar structures and features to those of produce ripening apparatus 100.

Produce ripening apparatus 200 may include sealed inner package 202 positioned inside sealed outer package 204. Sealed inner package 202 may be breakable upon engagement of pin device 212. Sealed inner package 202 may seal a ripening agent inside sealed inner package 202. Sealed outer package 204 may be openable (e.g., a zip lock seal or partition). Apparatus 200 may also include ripeness indicator 208 visible outside of sealed outer package 204. Ripeness indicator 208 may be configured to indicate a degree of ripeness of produce 210 in sealed outer package 204 in response to detecting a concentration of a substance associated with produce 210 that indicates the degree of ripeness of produce 210.

In an implementation, a push button valve 214 may be depressed by a user. In response, a needle 216 on a lower portion of valve 214 may puncture sealed inner package 202, which may be an ethylene gas section of a two-part bag (e.g., sealed inner package 202 and sealed outer package 204). The pin device or push button valve may be engageable via button 220. Upon actuating button 220, a seal of sealed inner package 202 may be broken and ripening agent 206 may enter sealed outer package 204 from the inner package. Sealed inner package 202 may not include a seal and may be punctured in response to actuation of the pin device.

In an implementation, a gas exchange tube 218 may be in communication with the punctured inner package 202 (e.g., via pin device 212) and may allow a ripening agent 206 (e.g., ethylene) to flow from punctured inner package 202 into outer package 204. Valve 214 and gas exchange tube 218 may be up to 5 inches in length and may be made from various metals or plastics.

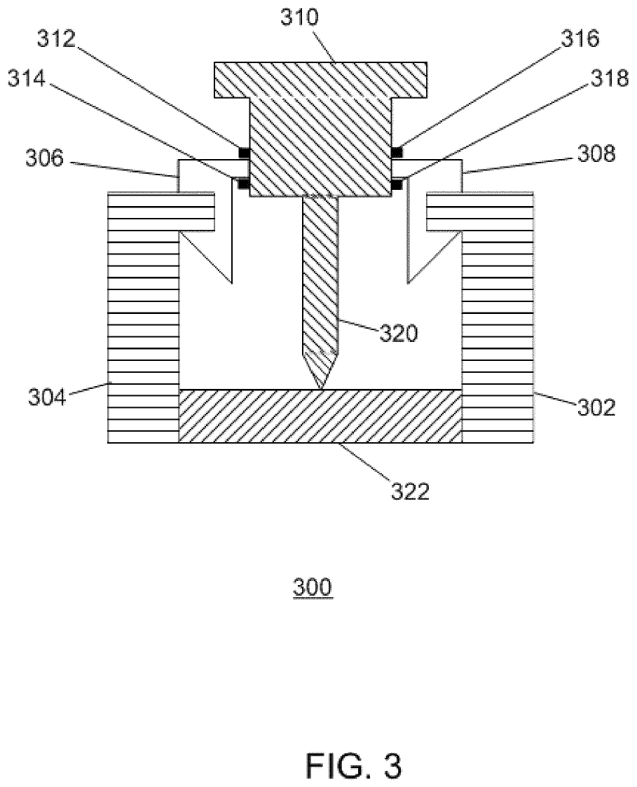

Referring now to FIG. 3, an example pin device in accordance with the present disclosure is shown. Pin device 300 may include lower housing members 302 and 304, upper housing members 306 and 308, and push button 310. Push button 310 may be connected to pin 320 which may interface with penetrable membrane 322. Nubs 312, 314, 316, and 318 (or other physical members) may hold the pin/push button in place axially. A slight interference with the upper housing members may be overcome by hand force on the push button, which may then puncture the penetrable membrane. In an implementation, an inner packaging and/or outer packaging may be sealed in between upper housing members 306 and 308.

In an implementation, elements 312 and 316 may be ends of the same component and elements 314 and 318 may be ends of the same component. These two components (i.e., a first component having ends 312 and 316 and a second component having ends 314 and 318) may be annular ribs or pins with slightly larger than pin shaft diameters and may represent an interference with a bore (not shown) of, for example, upper housing member 306 (or 308). This interference may prevent pin 320 from sliding down or penetrating penetrable membrane 322 but may be overcome by application of force to pin 310 (e.g., force of a person's thumb).

One or more of sealed inner package 202, sealed outer package 204, and ripeness indicator 208 of produce ripening apparatus 200 may be the same as or similar to sealed inner package 102, sealed outer package 104, and ripeness indicator 108 of produce ripening apparatus 100, respectively, and may have variations in material strength, size, and or position. For example, sealed inner package 202 may be positioned under pin device 212 such that pin device 212 may puncture sealed inner package 202. In an implementation, sealed inner package 202 may be fixed to pin device 212 or fixed under pin device 212. Further, sealed inner package 202 and/or sealed outer package 204 may be larger, stronger, more rigid, less elastic, or less flexible than sealed inner package 102 and/or sealed outer package 104, respectively.

It should be noted that while embodiments with regard to FIG. 1 have been discussed in the context of a consumer product and embodiments with regard to FIG. 2 have been discussed in the context of a commercial product for retailer use, these are not intended to be limitations of the present disclosure and embodiments discussed with regard to either FIG. 1 or FIG. 2 may be used or purchased in a warehouse, store, or home context.

In an implementation, a store worker may actuate pin device 212 in a store in order to ripen produce being sold at the store in a desired manner or timeframe. The store worker may then use the ripeness indicator (e.g., ripeness indicator 208) to determine the ripeness for the produce, open outer package 204 (which may be reusable or resealable), and remove the produce for sale at an optimal or desired ripeness level. At least one of sealed inner package 202 and sealed outer package 204 may be reusable or resealable.

In an implementation, produce ripening apparatus 200 may include a scanable bar code or otherwise include other electronically readable information to keep track of when pin device 212 was engaged such that the store worker can be notified of when the produce in produce ripening apparatus 200 becomes ripe.

In an implementation, produce ripening apparatus 200 may be sold without produce and/or a ripening agent. For example, a store worker may add the ripening agent and/or produce later and sell the produce from the produce ripening apparatus once the produce has become ripe. As discussed above, because at least one of sealed inner package 202 and sealed outer package 204 may be reusable or resealable, the store worker may add ripening agent and/or produce, release the ripening agent, and remove and sell produce using the same produce ripening apparatus multiple times in order to save time, money, and other resources.

A number of implementations have been described. Nevertheless, it will be understood that the foregoing description is intended to illustrate, and not to limit, the scope of the inventive concepts which are defined by the scope of the claims. Other examples are within the scope of the following claims.

What is claimed is:

1. A produce ripening apparatus comprising:
a sealed inner package positioned inside a sealed outer package, the sealed inner package being breakable and sealing a ripening agent inside the sealed inner package, the sealed outer package being openable and having an elasticity sufficient to allow pressure to be applied to the sealed inner package through squeezing of the sealed outer package without breaking the sealed outer package, the pressure sufficient to break the sealed inner package.

2. The produce ripening apparatus of claim 1, further comprising:
a ripeness indicator visible outside of the sealed outer package, the ripeness indicator configured to indicate a degree of ripeness of produce in the sealed outer package in response to detecting a concentration of a substance associated with the produce that indicates the degree of ripeness of the produce.

3. The produce ripening apparatus of claim 1, wherein at least one of the sealed inner package and the sealed outer package is at least one of: made from a polymer; substantially transparent;
and resealable.

4. The produce ripening apparatus of claim 1, wherein the sealed outer package seals a substance inside the sealed outer package to preserve produce in the sealed outer package.

5. The produce ripening apparatus of claim 1, wherein produce inside the sealed outer package is exposed to the ripening agent once the sealed inner package is broken.

6. The produce ripening apparatus of claim 1, wherein the ripening agent is ethylene.

7. The produce ripening apparatus of claim 2, wherein the ripeness indicator indicates a degree of ripeness of the produce via a color-coded indicator.

8. The produce ripening apparatus of claim 1, further comprising:
a valve extending from inside of the sealed inner package through which the seal of the sealed inner package is breakable, wherein, upon breaking the seal of the sealed inner package, the ripening agent enters the sealed outer package through the valve.

9. The produce ripening apparatus of claim 1, further comprising:
produce in the sealed outer package.

10. The produce ripening apparatus of claim 1, wherein the produce is a banana.

11. A produce ripening apparatus comprising:
a sealed inner package positioned inside a sealed outer package, the sealed inner package being breakable upon engagement of a pin device, the sealed inner package sealing a ripening agent inside the sealed inner package, the sealed outer package being openable.

12. The produce ripening apparatus of claim 11, further comprising:
a ripeness indicator visible outside of the sealed outer package, the ripeness indicator configured to indicate a degree of ripeness of produce in the sealed outer package in response to detecting a concentration of a substance associated with the produce that indicates the degree of ripeness of the produce.

13. The produce ripening apparatus of claim 11, wherein the pin device is engageable via a button, and upon actuating the button, a seal of the sealed inner package is broken and the ripening agent enters the sealed outer package from the inner package.

14. The produce ripening apparatus of claim 11, wherein at least one of the sealed inner package and the sealed outer package is at least one of: made from a polymer; substantially transparent; and resealable.

15. The produce ripening apparatus of claim 11, wherein the sealed outer package seals a substance inside the sealed outer package to preserve produce in the sealed outer package.

16. The produce ripening apparatus of claim 11, wherein the ripening agent is ethylene.

17. The produce ripening apparatus of claim 11, wherein the ripeness indicator indicates a degree of ripeness of the produce via a color-coded indicator.

18. The produce ripening apparatus of claim 11, further comprising:
produce in the sealed outer package.

19. The produce ripening apparatus of claim 11, wherein the produce is a banana.

20. A produce ripening apparatus comprising:
a sealed inner package positioned inside a sealed outer package that is substantially transparent, the sealed inner package being breakable and sealing a ripening agent inside the sealed inner package, the sealed outer package being openable and having an elasticity sufficient to allow pressure to be applied to the sealed inner package through squeezing of the sealed outer package without breaking the sealed outer package, the pressure sufficient to break the sealed inner package;
a ripeness indicator visible outside of the sealed outer package, the ripeness indicator configured to indicate a degree of ripeness of produce in the sealed outer package in response to detecting a concentration of a substance associated with the produce that indicates the degree of ripeness of the produce; and
wherein the produce inside the sealed outer package is exposed to the ripening agent once the sealed inner package is broken.
